(19) United States
(12) Patent Application Publication
(10) Pub. No.: US 2005/0077657 A1
(43) Pub. Date: Apr. 14, 2005

(54) A Method of Making a Multichannel and Multilayer Pharmaceutical Device

(75) Inventors: UMAR M. AHMAD, HOPEWELL JUNCTION, NY (US); RASCHID J. BEZAMA, MAHOPAC, NY (US); JAMES N. HUMENIK, LAGRANGEVILLE, NY (US); JOHN U. KNICKERBOCKER, WAPPINGERS FALLS, NY (US); GOVINDARAJAN NATARAJAN, PLEASANT VALLEY, NY (US); RAO V. VALLABHANENI, HOPEWELL JUNCTION, NY (US)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, ARMONK, NY (US)

(21) Appl. No.: 10/605,615

(22) Filed: Oct. 14, 2003

(51) Int. Cl. C03B 29/00; C04B 33/32; B28B 1/00

(52) U.S. Cl. 264/629; 156/89.11

(57) ABSTRACT

A plate for use in mixing and testing materials in the pharmaceutical industry is formed by a method in which apertures in a set of greensheets are formed by a material removal process, at least some of the apertures being filled with a composite material combining a durable matrix material that remains in the final structure and a temporary material that is removed after the sintering step. An array of apertures is formed in a template plate by photolithographic means and transferred to an adjacent greensheet.

### CROSS REFERENCE TO RELATED APPLICATIONS

The field of the invention is that of simultaneously testing many compounds for biological/chemical interactions. In particular, the current invention is a device/structure and a method to test drug interactions.

### BACKGROUND OF INVENTION

In the pharmaceutical industry, it is necessary to test the reaction (including biological activity) of chemical A to chemicals B₁-Bₙ where n can be a large number, on the order of millions.

A popular method is that of providing an array of substances B₁-Bₙ on a plastic card and placing substance A in contact with each of the Bₙ. Commercially available plastic card arrays include 96 and 384 wells. The well diameters are of the order of few millimeters. The method of chemical placement or dispensing usually is by micro pipettes. There are computer assisted scanners used to type the chemical interactions.

Since there are millions of combinations of chemicals to test to exhaust the possibilities, it takes years for companies that are involved in drug discovery, to bring a successful drug to the market. With the current speed of computer assisted scanning devices, it is possible to reduce the drug discovery time, for example, by increasing the number of samples scanned at a time. This is possible if we can pack more number of wells, for example, in a given volume. A larger number of wells in a given volume also reduces the amount of costly chemicals to be used in a given well.

The plastic cards are usually formed by extrusion and the precision of the hole diameter and location within the array is not adequate enough to fabricate micro holes and channels. This essentially limits the extendability of plastic in this field.

The pharmaceutical industry is searching energetically for micro devices, with multiple thousands of wells with diameters of the order of 100 microns and channels connecting the selective wells at different levels within the array.

### SUMMARY OF INVENTION

The invention relates to a ceramic device with micro wells and micro channels and a method for formation thereof.

A feature of the invention is the fabrication of an array of micro wells and micro channels in a ceramic structure by laminating multiple personalized green sheets.

In an aspect of the invention, a multi-layer array of wells and channel structure contains a set of structures filled with a material that can be removed after sintering to form channels.

Another feature of the invention is the use of a sacrificial material that leaves a residue of a porous structure whose pores are connected after sintering.

Another feature of the invention is the use of a sacrificial material that remains in the ceramic structure during the sintering process to preserve a porous structure and that is removed after the sintering process.

Another aspect of the invention is the control of the channel volume during sintering process.

### BRIEF DESCRIPTION OF DRAWINGS

FIG. 1 shows a completed structure after a first version of the process.

FIGS. 2A-2C show separate layers before sintering.

FIG. 3 shows a structure after the sintering step of the process.

FIG. 4 shows the result of opening the porous structure.

FIG. 5 shows steps in the process with improved accuracy of pattern location.

### DETAILED DESCRIPTION

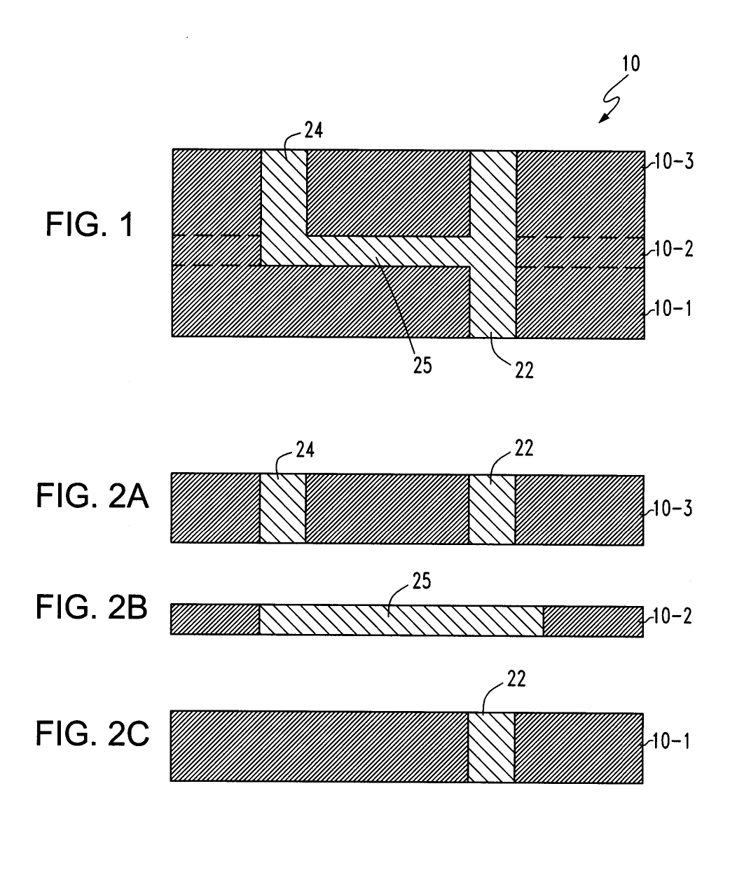

FIG. 1 shows a portion of a simplified completed structure 10 according to the invention, having a single horizontal channel 25 formed in a sheet 10-2 connecting a first vertical aperture 22 formed in sheets 10-1, 10-2 and 10-3 and a second aperture 24 formed in sheet 10-3. Sheets 10-1 to 10-3 were initially separate ceramic greensheets that have been laminated and sintered to form ceramic plate 10. In operation, a substance may be forced upward through sheet 10-1, diverge and exit in two or more locations in sheet 10-3. Similarly, the flow could be in the opposite direction, with two substances entering through two or more apertures in sheet 10-3, combining and exiting through the single opening in sheet 10-1. The final structure 10 is preferably a single sintered body with sheets 10-1, 10-2 and 10-3 of identical materials. Alternatively, sheets 10-1, 10-2 and 10-3 can be a set of different materials.

FIG. 1 shows a structure formed using 3 green sheets and 1 horizontal channel connecting two vertical wells for simplicity in illustration. The structure has been assembled from individual sheets by lamination and sintering. The assembly process is the same for ceramic structures with arrays of thousands of holes, with thousands of horizontal channels selectively connected to link vertical holes. The ceramic material may include alumina, glass ceramic, aluminum nitride, borosilicate glass and glass. The diameter of vertical wells can be 20 microns or more, the channel width can be 20 microns or more and the length can be a minimum of 20 microns. The shape of a well exposing a substance may be circular, rectangular, smooth or rough. The total thickness of the plate 10 may be any desired amount, but preferably is under 1 mm. The thickness of the greensheet depends on the application, but preferably ranges from about 1 mil to about 30 mils.

The lamination process involves heat, pressure and time. The preferred lamination pressure is under 800 psi, the temperature is under 90 deg C. and for a time of less than 5 minutes. The sintering process involves the material of choice and the binder system used to form the greensheets.

FIGS. 2A through 2C show the separate greensheets 10-1, 10-2 and 10-3 that have been laminated and sintered to form the structure of FIG. 1. Illustratively, horizontal channel 25 has a length greater than twice the diameter of an aperture 22 or 24. Illustratively, apertures 22 are about 20 microns or more in diameter. The diameter used in fabrication will depend on the particular application and technical variables such as the viscosity of the substance passing through, the surface tension/activity of the surface and fluid, desired flow force, capillary or forced flow, desired quantity and rate of flow, etc.

According to the invention, the greensheets are formed from a substance such as alumina, glass, ceramic and glass and ceramic. The technique for forming vertical apertures and horizontal channels is material removal by techniques such as punching the material out including nibbling, laser drilling, e-beam drilling, sandblasting and high pressure liquid jets. A single sheet may have up to several thousands holes and channels per square inch.

Micromolding by pressing the material to the side and distorting the greensheet is not included in the preferred embodiments and will be referred to generally as a material displacement technique. Such techniques are undesirable, since the desired well and channel position accuracy with respect to each other is very small, e.g. a few microns, and the distortions introduced by material displacement techniques are a significant obstacle to providing the desired accuracy.

According to a design choice, the vertical holes in the greensheet may be filled with a fugitive material that escapes during the sintering step or they may be filled with a material that remains during sintering and is removed afterward. Alternately, a fugitive material that is removed during sintering as well as a temporary material that is removed post sintering can be used.

The fugitive materials for a first embodiment may be any compatible organic material such as terepthalic acid, carbon, or other organic materials. In a second embodiment, the material filling passageways may be a mixture of particles with pores in between and a temporary material filling the pores. The particles are durable and remain in the final product. The temporary material is removed after sintering to open up the pores.

The materials to form the porous structures in the second embodiment may be ceramics such as alumina, glass ceramic, aluminum nitride and borosilicate glass, illustratively in a particle size of less than 40 microns. The ratio of materials is chosen such that there is a matrix of durable material interspersed with the temporary material that extends continuously through the matrix so that, when the temporary material is removed, there remains a set of passages that permit the reagent to flow.

In a first embodiment of the invention, some of the greensheets contain the fugitive material in the passages that will become vertical channels after the fugitive material escapes during sintering. The process of removing the fugitive material may involve heating it past the boiling or subliming temperature, so that the material goes off in vapor form into the ambient; or the technique may involve burning or other chemical reaction that combines the molecules of the fugitive material with the molecules of a reactant gas to from a substance that is a gas and goes into the ambient. The form of the fugitive material is preferably one that is easy to apply into the apertures in the greensheet, e.g. in the form of a paste.

In the second embodiment, a first material that will remain in the final product is combined with a second material that will form a porous structure on being sintered; e.g. a mixture of fugitive material in particle form, the particle size being sufficiently large that the particles touch in the unfired state. Therefore, a continuous open structure will remain in an open-pore matrix after sintering to permit the passage of a test material through the pores from one side of the plate 10 to the other. The unsintered porous body in the channel forms controlled open volume and channel dimensions that have a specified fraction of open space after firing.

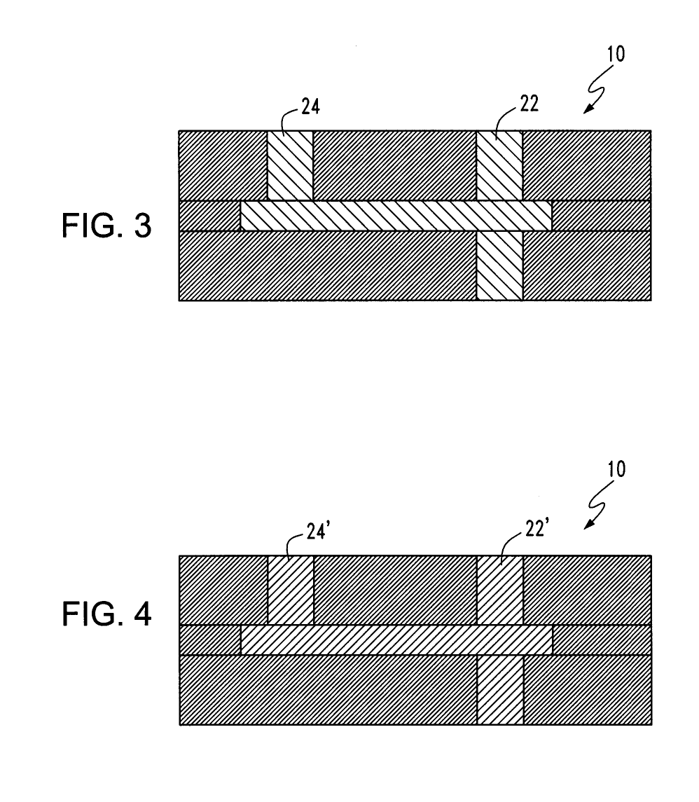

FIG. 3 is a counterpart to FIG. 1, showing a structure after the sintering process, in which vertical apertures 22 and 24 are filled with the composite material before sintering and the horizontal channel 25 has a porous matrix. Both horizontal channel 25 and vertical passages 22 and 24 were filled before sintering with a filler material that is a mixture of the removable material and a matrix material that sinters to form a porous matrix having open pores that permit the passage of a fluid through it from vertical aperture 22 to vertical aperture 24.

FIG. 4 shows the result after removal of the temporary material either by heating the structure above the sintering temperature to the boiling or subliming temperature of the temporary material or by etching the temporary material in a process using a solvent that does not attack the matrix.

An example of filler material may be alumina or zirconia, and/or metals such as molybdenum, copper, silver or nickel. Materials that may be removed by subliming include molybdenum, copper and nickel. Materials that may be removed by heating above the melting point include copper, silver and nickel.

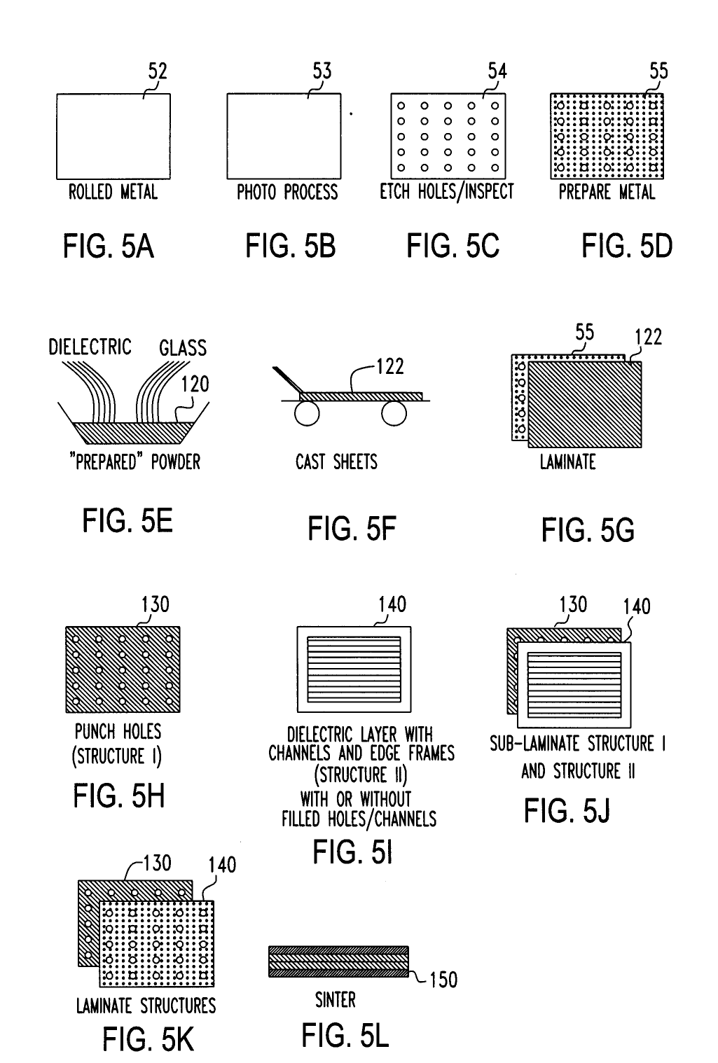

Referring to FIG. 5, there is shown a sequence of steps in the process according to the invention. In the first row, FIGS. 5A-5D show steps in the formation of a metal support plate, starting with a blank metal sheet 52 (having a thickness of about 3 mils ) in FIG. 5A, then using a photolithographic process to form a layer of photoresist containing an array of apertures to form plate 53. The accuracy of definition of the apertures and their location using this lithographic technique is considerably greater than is possible using conventional techniques applied to plastic plates. Typical tolerances are less than 1 micron.

As shown in FIG. 5C, the metal plate is etched through the resist to form a plate 54 containing an array of holes, illustratively forming the start of vertical apertures 22 in FIG. 1. Illustratively, the diameter of the apertures is about 20 microns. The channels may be formed using a similar technique.

FIG. 5D shows the plate after preparation for receiving the ceramic greensheet layers. The preparation steps may include oxidation of surfaces or coating the surfaces with an adhesion promoter that aids bonding to greensheets.

FIG. 5E shows a step of mixing the material for the greensheet in which a dielectric material such as alumina, glass ceramic, aluminum nitride is mixed with a glass powder that acts as a binder. In FIG. 5F, the mixed material is cast to form a layer having a nominal thickness of about 1 mil to 30 mils.

Next, as shown in FIG. 5G, the greensheet 122 is placed on support plate 55 and the holes in plate 55 are transferred to greensheet 122 by any convenient material removal technique discussed above using metal plate 55 as a template (referred to as the template plate) to form the array of holes in FIG. 5H in a pattern transfer step.

FIG. 51 shows the result of a parallel sequence in which a second plate 140 is formed with other structures required by the design being implemented, such as horizontal channels 25. Either of the structures 130 or 140 may have edge frames (e.g. metal) surrounding the greensheet for handling and controlling the array dimensions. Preferably, only the top and bottom layers have a sheet of metal for pattern transfer.

In the bottom row, two greensheets 130 and 140 are aligned before the laminating step of FIG. 5K, in which the two sheets are laminated. The result is shown in FIG. 5L, showing the structure after sintering, in which the sheets fuse together to form a solid block. The fugitive and temporary materials in the holes and channels are removed by any of the above methods.

Alternative forms of the invention include using a densifiable material for the greensheets and filling the openings with a non-densifiable material in order to preserve the dimensions of the passages. For example, the matrix material may be an inorganic phase like alumina mixed with glass frit for densification, whereas the non-densifiable phase in the channel (and or holes) could be just larger ceramic particles like alumina.

Additionally, the material in the passages may be one that forms a non-porous sheath on being sintered, so that the passages receive a liner, such as that the sheath has alternate surface energy/activity than the matrix material/the body of the plate 10. The material for the sheath can be inorganic, metal or composite. The sheath formation may be due to chemical decomposition between a first material in the laminate and a second material in the filler or in the ambient gas and/or the sheath formation may be due to vapor phase deposition. As another option, the liner could be produced by a vapor emitted by the filler material that deposits on the walls or reacts with a material contained in the laminate.

While the invention has been described in terms of a several preferred embodiments, those skilled in the art will recognize that the invention can be practiced in various versions within the spirit and scope of the following claims.

1. a method of forming a plate for the passage through a set of apertures of at least one substance from a first side to a second side comprising the steps of:
forming a plurality of vertical apertures in a first ceramic greensheet;
forming a plurality of horizontal apertures in a second ceramic greensheet;
forming a plurality of vertical apertures in a third ceramic greensheet, in which at least some of said horizontal apertures in said second greensheet connect an aperture in said first greensheet with an aperture in said third greensheet;
filling at least some of said apertures with a filler material containing a temporary material and a matrix material;
laminating said first, second and third ceramic greensheets together;
sintering said first, second and third greensheets at a sintering temperature, thereby forming said plate containing said filler material filling passages therein;
and removing said temporary material, thereby creating a set of passages through said matrix.

2. A method according to claim 1, in which:
said step of removing said temporary material is effected by heating said plate above said sintering temperature to a removal temperature such that said temporary material escapes into the ambient.

3. A method according to claim 2, in which:
said temporary material is a material that sublimes at said removal temperature.

4. A method according to claim 3, in which:
said temporary material is selected from the group comprising metals such as molybdenum, cooper and nickel.

5. A method according to claim 2, in which:
said step of removing said temporary material is effected by heating said plate above said sintering temperature to a removal temperature above a melting point of said temporary material.

6. A method according to claim 5, in which:
said temporary material is selected from the group comprising copper, silver, nickel.

7. A method according to claim 1, in which:
said step of removing said temporary material is effected by dissolving said temporary material in a solvent.

8. A method according to claim 1, in which:
apertures in at least one of said first, second and third greensheets are filled with a fugitive material that escapes into the ambient during said step of sintering.

9. A method according to claim 2, in which:
apertures in at least one of said first, second and third greensheets are filled with a fugitive material that escapes into the ambient during said step of sintering.

10. A method according to claim 5, in which:
apertures in at least one of said first, second and third greensheets are filled with a fugitive material that escapes into the ambient during said step of sintering.

11. A method according to claim 7, in which:
apertures in at least one of said first, second and third greensheets are filled with a fugitive material that escapes into the ambient during said step of sintering.

12. A method of forming a plate for the passage through a set of apertures of at least one substance from a first side to a second side comprising the steps of:
forming a plurality of vertical apertures in a first ceramic greensheet;
forming a plurality of horizontal apertures in a second ceramic greensheet;
forming a plurality of vertical apertures in a third ceramic greensheet, in which at least some of said horizontal apertures in said second greensheet connect an aperture in said first greensheet with an aperture in said third greensheet;
filling a first set of apertures with a fugitive material;
filling a second set of apertures with a composite material comprising a matrix material and a filler material;
laminating said first, second and third ceramic greensheets together;
sintering said first, second and third greensheets at a temperature such that said fugitive material escapes into the ambient;
and removing said filler material.

13. A method according to claim 12, in which:
said step of removing said temporary material is effected by heating said plate above said sintering temperature to a removal temperature such that said temporary material escapes into the ambient.

14. A method according to claim 13, in which:
said temporary material is a material that sublimes at said removal temperature.

15. A method according to claim 14, in which:
said temporary material is selected from the group comprising molybdenum, copper and nickel.

16. A method according to claim 12, in which:
said step of removing said temporary material is effected by heating said plate above said sintering temperature to a removal temperature above a melting point of said temporary material.

17. A method according to claim 16, in which:
said temporary material is selected from the group comprising copper, silver, nickel.

18. A method according to claim 12, in which:
said step of removing said temporary material is effected by dissolving said temporary material in a solvent.

19. A method of forming a plate for the passage through a set of apertures of at least one substance from a first side to a second side comprising the steps of:
forming an array of apertures by a photolithographic process in at least one template plate;
forming a first ceramic greensheet disposed on said template plate;
transferring said array of apertures from said template plate to said first ceramic greensheet to form a first array of passages in said first ceramic greensheet;
forming a second array of passages through a second ceramic greensheet connecting to said first array of passages;
laminating said first and second ceramic greensheets together;
sintering said first and second greensheets at a sintering temperature, thereby forming a plate containing passages therein extending from a first side to said second side opposite said first side.

20. A method according to claim 19, further comprising:
filling at least one set of passages with a temporary material before said step of laminating;
and removing said temporary material.

21. A method according to claim 20, further comprising filling a set of apertures with a composite material comprising a durable matrix material that forms a porous matrix during said sintering step and a temporary material, whereby said porous matrix permits passage of a reagent in operation.

22. A method according to claim 19, further comprising:
forming a second template plate containing a second array of apertures;
forming said second array of passages in said second ceramic greensheet connecting to said first array of passages by transferring said second array of apertures to said second ceramic greensheet.

23. A method according to claim 22, further comprising:
forming at least one intermediate ceramic greensheet disposed between said first and second ceramic greensheets and containing a set of intermediate horizontal passages connecting passages in said first and second ceramic greensheets.

24. A method according to claim 23, further comprising filling a set of apertures in one of said first, second and intermediate greensheets with a composite material comprising a durable matrix material that forms a porous matrix during said sintering step and a temporary material, whereby said porous matrix permits passage of a reagent in operation.

25. A method according to claim 22, in which said step of removing said temporary material is effected by heating said plate above said sintering temperature to a removal temperature such that said temporary material escapes into the ambient.

26. A method according to claim 25, in which:
said temporary material is a material that sublimes at said removal temperature.

27. A method according to claim 23, in which:
said temporary material is selected from the group comprising molybdenum, copper and nickel.

28. A method according to claim 23, in which:
said step of removing said temporary material is effected by heating said plate above said sintering temperature to a removal temperature above a melting point of said temporary material.

29. A method according to claim 28, in which:
said temporary material is selected from the group comprising copper, silver, nickel.

30. A plate comprising a set of apertures for the passage of at least one substance from a first side to a second side comprising:
a plurality of vertical apertures in a first ceramic sintered greensheet;
a plurality of horizontal apertures in a second ceramic sintered greensheet;
a plurality of vertical apertures in a third ceramic sintered greensheet, in which at least some of said horizontal apertures in said second sintered greensheet connect an aperture in said first sintered greensheet with an aperture in said third sintered greensheet;
and at least one supporting plate abutting one of said first and third ceramic sintered greensheets and having a pattern of said apertures defined therein, whereby said apertures may be transferred accurately from said supporting plate to said one of said first and third sintered ceramic greensheets.

31. A plate according to claim 30, in which:
said plate comprises two supporting plates abutting both said first and said third sintered greensheets.

32. A plate according to claim 30, in which:
said plate comprises a supporting plate abutting first sintered greensheet.

33. A plate according to claim 30, in which:
said plate comprises a supporting plate abutting said third sintered greensheet.

34. A plate according to claim 30, in which:
said plate further comprises at least one intermediate plate abutting one of said first and said third sintered greensheets and comprising an edge frame and a structural component disposed within said edge frame.

35. A plate according to claim 34, in which:
said plate further comprises at least one intermediate plate abutting said first sintered greensheet and comprising an edge frame and a structural component disposed within said edge frame.

36. A plate according to claim 30, in which: said plate further comprises at least one intermediate plate abutting said third sintered greensheet and comprising an edge frame and a structural component disposed within said edge frame.
